(19) United States
(12) Patent Application Publication
(10) Pub. No.: US 2007/0213047 A1
(43) Pub. Date: Sep. 13, 2007

(54) PLACING ORDERS FROM A MOBILE VEHICLE

(76) Inventor: Hal Kolker, Boca Raton, FL (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/748,855

(22) Filed: May 15, 2007

Related U.S. Application Data
(63) Continuation-in-part of application No. 11/345,075, filed on Jan. 31, 2006.

(51) Int. Cl. H04Q 7/20

(52) U.S. Cl. 455/428

(57) ABSTRACT

Placing orders comprises an input device mounted on a mobile vehicle. The mobile vehicle is owned or operated by a first entity and the vehicle is for transporting a passenger between different locations, the passenger being different to the owner or operator. The mobile vehicle is a taxi, limousine or public transportation vehicle. The input device is selectively a PC, mobile phone, PDA unit associated with the vehicle. The association is such that when an order is made from that device by the passengers, at least one of the owner or operator of the vehicle obtains a financial benefit from the order by the passengers. A payment is made to the operator or owner of the vehicle in respect to purchases made by the passenger from the mobile vehicle.

### RELATED APPLICATION

This application is a Continuation-In-Part of U.S. application Ser. No. 11/345,075, filed Jan. 31, 2006, the content of which is incorporated by reference herein in its entirety.

### BACKGROUND

The disclosure relates generally to placing orders from a mobile vehicle. More particularly, the disclosure relates to a sales system and method that targets consumers such as passengers based on the geographic location of the mobile vehicle carrying the passengers.

Consumers are generally aware of sporting events, theatre performances, operas, concerts, and other events that require tickets in the geographic area in which they reside. They typically learn of these events through local newspapers, radio, television, the Internet, and other commercial media. If interested in purchasing tickets, the consumer may call the venue hosting the event or access their website to see if tickets are still available. The consumer may then purchase the tickets over the phone, through the venue's website, or at the box office located at the event.

Consumers may also be generally aware of restaurants, dinner theatres, spas, and other commercial service providers in their geographic area. Many of these providers require reservations or offer special deals and discounts. Consumers generally learn of these offers in an ad hoc fashion by perusing newspapers, the Internet or by “word of mouth.” At high demand times, some providers may require reservations, other providers may prefer reservations, and still others may not take them at all. High demand times are not necessarily obvious to consumers. A consumer may be able to infer that Friday and Saturday nights are high demand times for a trendy new downtown restaurant and that a reservation might be prudent. However, the consumer may not infer that reservations are required for a Tuesday 5:00 PM seating at a local Cincinnati restaurant on Pete Rose Way, if they are unaware the Reds are playing an evening game down the street.

Frequently providers will adjust the price of their goods and services based on a change in demand. For example, box offices may lower the price of tickets the night before a performance. However, consumers willing to purchase these “last minute” tickets are often unaware that they are even available. Even a consumers who is aware of the possibility of purchasing one of these “last minute” tickets must monitor the Internet, call the box office, or show up at a ticket sale location to find out if tickets are available.

Similarly, restaurants might offer discount meals or cocktails at certain hours to fill the seats in the restaurant. Additionally, movie theatres, spas, and other service providers may offer “come on” advertisements and sales to balance capacity with the fluctuating demand. Once again, consumers are often unaware of many of these opportunities available to them.

This dearth of information results in market inefficiencies. Some goods and services providers frequently lower their prices more than necessary because interested consumers are not aware of the availability. Traditional advertising methods might target consumers based on the demographic information of patrons of the advertising medium. However, such targeting of consumers is often imprecise. Frequently, the information is out of date when the consumer acts on the information. For example, the provider's inventory may sell out or an item of inventory may now be selling at a premium or a discount price.

Furthermore, business travelers and vacationers are often unaware of goods and services available to them. For instance, a Celtics fan on business travel to Sacramento may not realize the Celtics are playing the Kings at Arco Arena and that tickets are available for half the price it would cost to have seen the game in Boston. This situation creates a loss for the Celtics fan and a loss for the owners of Arco Arena. That is, the Celtics fan misses a game he could have attended and the Arco Arena has an empty non-revenue generating seat.

Therefore, there exists a need for a system and method that is directed to consumers based on their geographic location, their subscriber profile, and their historic buying patterns.

There is a particular need to assist travelers, and more particularly passengers in mobile vehicles in which they are traveling.

### SUMMARY

The disclosure solves many of the above stated problems by more efficiently matching providers with consumers.

A system for placing orders comprises an input device mounted on a mobile vehicle. The mobile vehicle is owned or operated by a first entity and the vehicle is for transporting a passenger between different locations, the passenger being different to the owner or operator. The mobile vehicle is a taxi, limousine or public transportation vehicle.

The input device is selectively a PC, mobile phone, PDA unit associated with the vehicle; the association being such that when an order is made from that device by the passengers, at least one of the owner or operator of the vehicle obtains a financial benefit from the order by the passengers. The association of the input device with the vehicle includes a receptacle built into the vehicle for receiving the PC, mobile phone, or PDA unit, the unit being physically and electronically associated with the vehicle. The association of the input device with the vehicle includes hardware and software in the vehicle for interaction with the input device.

The placing of the order can be the making of a reservation for an entertainment or sporting event. The goods or services are delivered electronically in the form of a voucher, a ticket receipt or reservation. The goods or services are priced at a discount relative to a full price of the goods or services. The goods or services can be dated. In this sense the goods or services are regarded as expiring inventory. Thus the closer to the date of an event or entertainment happening, the cheaper the price that can be offered to the person making a reservation from the mobile vehicle. Similarly goods may have an expiry characteristic, for instance freshness—such as food or flowers, and in that event overstocked food or flowers can be priced like expiring inventory of services.

The disclosure does this by taking inventory information (e.g., available goods or services) from a provider and matching the inventory information with an individual subscriber based on the subscriber's current geographic location in a mobile vehicle and/or the subscriber's profile.

The disclosure includes functional components that manage a provider's inventory information, target advertising to a subscriber, and execute a transaction between the provider and the subscriber. These functions may be performed using a base station having multiple computer clusters that include a server coupled to multiple processors with access to a database. The computer clusters may be controlled by a master server that manages the activities of each of the computer clusters. The topology of the base station provides a high speed, fault tolerant computing platform for matching potential buyers (subscribers) with sellers (providers).

Inventory providers may specify an inventory by uploading to the base station information about the items (e.g., goods or services) in the inventory. The base station may search its databases for subscribers who might be interested in the items and are located geographically near the items. For example, a provider may upload a list of seat numbers, row numbers, prices, and a date for a block of unsold tickets to a Dodger baseball game. The base station would search its subscriber database for subscribers whose profiles indicate they may be interested in the tickets and are currently near Dodger Stadium or in the Los Angeles area.

The base station may then prioritize subscribers based on the probability of sale, historic buying patterns and other data. After prioritizing the list of potential purchasers, the base station may build targeted advertisements to the subscribers. The messages can then be sent to a subscriber's electronic device alerting them that an item they may be interested in is now available. The messages may contain details about the item such as seat number, row number, and price and instruction on how to purchase the item.

Subscribers who receive the advertisement may make an electronic offer to purchase the item from their electronic device. The base station may receive the electronic offer to purchase and if the item is still available will accept the offer for completing the sales transaction. After completing the transaction, the computer may notify the buyer (i.e., the subscriber) and the seller (i.e., the provider) of the sale.

### DRAWINGS

The above-mentioned features and objects of the present disclosure will become more apparent with reference to the following description taken in conjunction with the accompanying drawings wherein like reference numerals denote like elements and in which:

FIG. 1 is a simplified block diagram of a system illustrating the various features of an embodiment of the disclosure.

FIG. 2 is a block diagram illustrating the components and connections between the components of the system according to an embodiment of the disclosure.

FIG. 3 is a flow diagram illustrating a method of inventory management according to an embodiment of the disclosure.

FIG. 4 is a flow diagram illustrating a method of subscriber profile management according to an embodiment of the disclosure.

FIG. 5 is a flow diagram illustrating a method of targeting advertisements to subscribers according to an embodiment of the disclosure.

FIG. 6 is a flow diagram illustrating a method of purchasing an item or making a reservation according to an embodiment of the disclosure.

FIG. 7 is a flow diagram illustrating the purchasing system in a mobile vehicle environment.

### DETAILED DESCRIPTION

Methods and systems that implement the embodiments of the various features of the disclosure will now be described with reference to the drawings. The drawings and the associated descriptions are provided to illustrate embodiments of the disclosure and not to limit the scope of the disclosure. Reference in the specification to “one embodiment” or “an embodiment” is intended to indicate that a particular feature, structure, or characteristic described in connection with the embodiment is included in at least an embodiment of the disclosure. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

In the various embodiments, some structures and features are described as being embedded or part of another structure. The location of the structures and features for a particular embodiment are provided for clarity in understanding the invention. The disclosure embraces many embodiments that can be realized by rearranging the structures and features described. For example, the functionality described as being located on a single computer cluster in one embodiment may be co-hosted with another function on a different computer cluster.

A system for placing orders comprises an input device mounted on a mobile vehicle. The mobile vehicle is owned or operated by a first entity and the vehicle is for transporting a passenger between different locations, the passenger being different to the owner or operator.

The input device is selectively a PC, mobile phone, PDA unit associated with the vehicle; the association being such that when an order is made from that device by the passengers, at least one of the owner or operator of the vehicle obtains a financial benefit from the order by the passengers.

The placing of the order can be the making of a reservation for an entertainment or sporting event.

The association of the input device with the vehicle includes a receptacle built into the vehicle for receiving the PC, mobile phone, or PDA unit, the unit being physically and electronically associated with the vehicle. The association of the input device with the vehicle includes hardware and software in the vehicle for interaction with the input device. The input device is selectively keys on a keyboard, a touch screen or voice activation.

There is a resource for orders of goods or services accessible by the input device associated with the vehicle. The resource of selected goods and services is allocated to the input device for placing orders for selected goods or services.

There is a network of different input devices with respective different mobile vehicles for accessing the system to place orders for the goods or services. Also there is a system for delivering the goods or services in response to the orders for the goods or services;

There is a system for billing for the selected and purchased goods or services and for submitting a commission or payment to the owner or operator of the mobile vehicle in proportion to a payment by the passenger for the supplied the goods and services. Further there is a system for making a payment to the resource of goods or services as a payment for those goods or services.

The goods or services are delivered electronically in the form of a voucher, a ticket receipt or reservation and wherein the system permits for an access to a service purchased, entertainment or supply of goods on presentation of the voucher, ticket, receipt or reservation.

The mobile vehicle is a taxi, limousine or public transportation vehicle.

The goods or services are determined for availability in relation to different geographical areas, and access to goods and services are related to the general location of a mobile vehicle in a designated geographical area relative to the goods in a geographical area related to the location of the vehicle.

The vehicle is related to its location in a defined geographical area, and wherein the goods and services are provided outside of the defined geographical area of the location of the movable vehicle, and providing for different goods or services for selected different geographical areas to be made available to the mobile vehicle relative to the location of the mobile vehicle, the different geographical areas being other than the defined geographical area.

The goods or services are priced at a discount relative to a full price of the goods or services, and preferably the discount being between about one third and one half of a full price for the goods and services. The goods or services are dated such that an event related to the goods or services expires on a first date and the availability of the goods or services made available to the mobile vehicle is limited to that time, such that the discount increases relative to a decrease in the time between access to the input device and the occurrence of an event represented by the goods or services.

The input device includes an interface permitting passengers being transported in the mobile vehicle to transact an order for goods or services and being for a reservation for entertainment, or for eating.

Alternatively, the input device is a permanently-mounted voice or data input system on the mobile vehicle, and a reservation voucher, ticket or receipt for entertainment or eating can be delivered to an e-mail address, other site or at a venue for the show or eating location.

The input device includes an input of credit card information selectively by a receiver permitting insertion of a credit card into a receptacle and including a printer for a voucher.

The vehicle housing for the input device is such that the housing includes, in part, a location in a compartment different to a passenger compartment of the vehicle.

The system for reporting includes the reporting of sales data and payment data, and the input device includes a unique electronic address, a tracking system for permitting an owner of a transportation system of multiple mobile vehicles employing the system, and a system to track sales of orders in respective mobile vehicles.

There is a network permitting access to reports by e-mail or fax, the network being accessible by a vehicle owner, a system operator and vendors of goods and services.

There is also a base station which includes a plurality of computer clusters having a server, a plurality of computers and a database; a master server that controls the activities of the servers in the plurality of computer clusters; an internet server connected with the master server; a database bridge connected with at least one of the plurality of computer clusters for downloading geographic position data of the mobile vehicle; and a telephone or data connection connected with at least one server and the input device with the mobile vehicle.

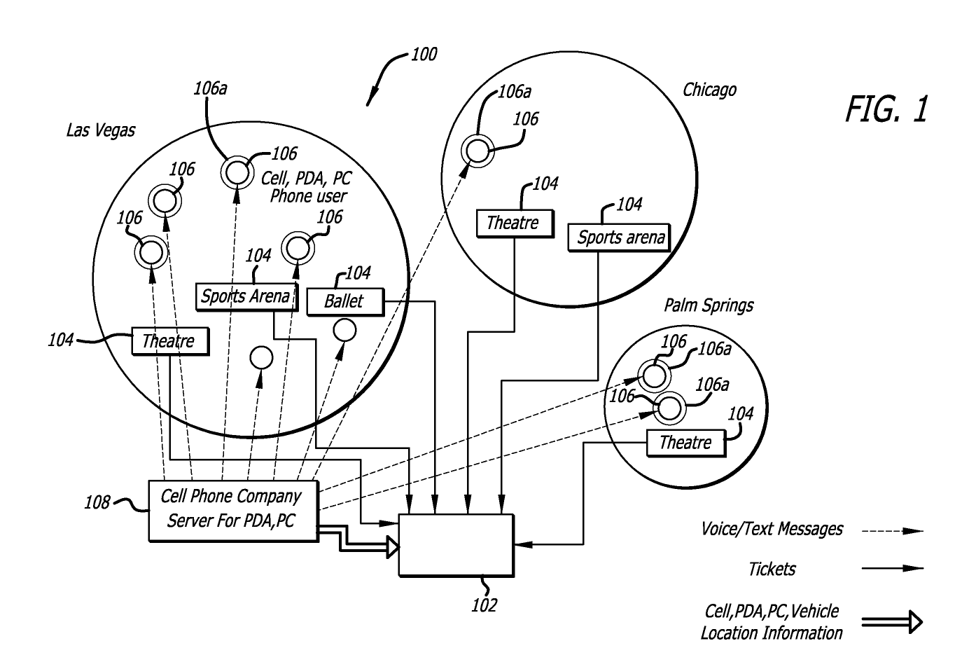

FIG. 1 is a simplified block diagram of a purchasing system 100 for goods and services illustrating the various features of an embodiment of the disclosure. The purchasing system 100 may include a base station 102 that receives for instance this ticketing information from a number of venues 104. The base station 102 also receives geographic position information about the location of a number of input devices (e.g., cell phones, PDA or PC) 106 that belong to a number of subscribers. The subscribers are mobile vehicles 106a. The base station 102 may include one or more databases and may search these databases for passengers in subscriber vehicle who may be interested in purchasing tickets and who are located near the venues 104. The base station 102 then creates a message (e.g., a text message, voice message, an interactive conversation or an email) targeting those passengers in the subscriber vehicle 106a. The message may be sent to the subscriber vehicles mobile input device 106. The passenger in a subscriber vehicle may then purchase a ticket using the input device 106 in the mobile vehicle 106a.

For example, a theatre (the Venetian Theatre) in Las Vegas may have a few tickets available for the “Blue Man Group” show. The theatre box office may upload information about the theatre tickets to the base station 102. The base station 102 may search its databases for subscribers in the Las Vegas area who are interested in the “Blue Man Group” show or in live theatrical performances (the genre). The base station 102 may even search for subscribers who have previously purchased tickets to live performances in Las Vegas (e.g., at the Venetian) indicating historic buying patterns. The base station 102 may build a list of these subscribers in the databases and prioritize them based on probability of sales, historic buying patterns, and other criteria. The base station 102 may send a targeted advertisement to a subscriber's input device 106 that reads “Four orchestra seats, row 10, seats 9-12, available for the Blue Man Group show in Las Vegas, reply to this message if interested in purchasing the tickets.” The base station 102 may engage in a structured text dialog using wireless communications (e.g., a cellular phone system 108) that provides supplemental information (e.g., price, times, location) and allows the passenger in subscriber vehicle to make selections (e.g., how many seats, which seats). If the subscriber indicates he wishes to purchase the tickets, the base station 102 may verify the seats are still available and execute the transaction. The base station 102 may then send a confirmation number or ticket number to the subscriber and notify the Venetian Theatre that the tickets have been sold.

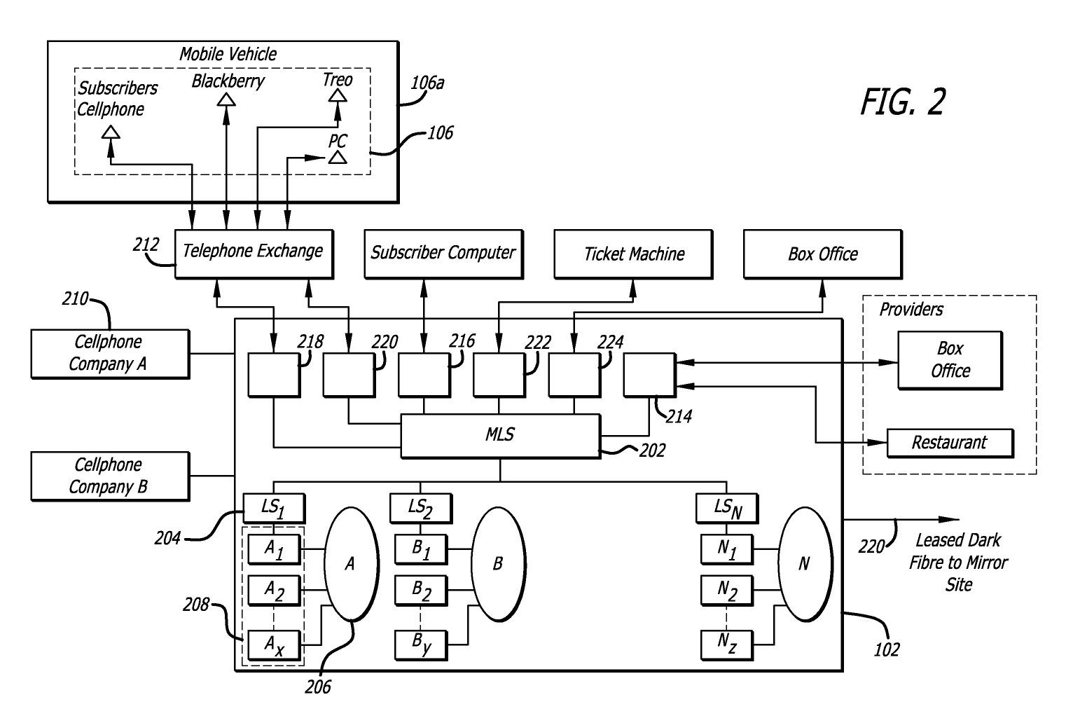

FIG. 2 is a block diagram illustrating the components and connections between the components of the ticket purchasing system 100 according to an embodiment of the disclosure. The base station 102 forms the hardware and software components of the disclosure. The base station 102 may be connected with multiple cell phone company servers and/or databases 210. Also, the base station 102 may be connected with a local telephone exchange 212 through an SMTP and POP3 server 218, or a touch tone and voice recognition server 220. Internet servers 214, 216, 222, 224 may connect the base station 102 to the Internet. A dark fiber connection 220 may connect the base station 102 to a sister site (e.g., a sister base station) (not shown).

The base station's 102 processing capability and databases may be mirrored at the sister site. The dark fiber connection 220 may virtually connect the sister site with the base station 102. In the event of a base station 102 system failure, the sister site may assume the operations of the base station 102 until the base station 102 is repaired, providing a redundant fail safe capability.

The base station 102 includes a master lockserver (MLS) 202 that controls the operations of one or more lockservers (LS) 204. Each lockserver 204 in turn controls one or more computers 208 with access to a corresponding database 206. The lockservers 204 may control the processes executed on each of the computers 208. The computers 208 may serve as gatekeepers for the databases 206. Also, the lockserver 204 may manage the individual failures of each of the computers 208 and corresponding databases 206. The computers 208 may have backup databases 206 and may have surplus computers allowing the lockserver 204 to workaround a failed computer or database. The lockserver 204 may notify the master lockserver 202 of any single point failures. An alert message, alarm, or report may be generated to alert base station 102 operators that there is a failure.

The master lockserver 202 and the lockservers 204 are computing platforms with locking software. The computing platform is preferably a high speed personal computer with at least one embedded Intel processor and a Windows or Linux operating system. Other embodiments may feature different processors, operating systems, and computing platforms. For example, the computing platform may be a Sun workstation with a UNIX operating system and a SPARC processor or an Apple Computer with an Apple O/S and a PowerPC processor.

There are also multiple suitable choices for the base station 102 (e.g., the computers 208 and the databases 206). A relational database such as mySQL hosted on a PC might be a suitable choice. Also, a Sybase or an Oracle database hosted on a UNIX platform may be a suitable choice.

One way of implementing the lockserver 204 is to have each of the computers 208 reports their status to the lockserver 204 every few seconds and request an assignment from the lockserver 204 if idle. If a computer 208 needs access to a record in the database 206, it first request permission from the lockserver 204. The lockserver 204 checks the “lock” status of the record. If the record is “locked,” the lockserver 204 denies the computer 208 access at that time. If the record is “unlocked,” the lockserver 204 changes the status of the record to “locked” and grants the computer 208 access to the database 206 at that time. The computer 208 may then access the record in the database 206. When the computer 208 has completed its access to the database 206, it reports to the lockserver 204 that it has completed access of the record. The lockserver 204 may then change the record status to “unlocked.”

The lockserver 204 may also maintain a queue of records to process. When idle, each computer 208 may query the lockserver 204 as to which record is next in the queue. The lockserver 204 may then change the status of the record to “locked” and grant the querying computer 208 the right to access the record. When the querying computer 208 is completed with the record, it reports that it has finished with the record and the lockserver 204 changes the status of the record to “unlocked.”

The base station 102 may have access to the cell phone company server and/or database 210 to update its databases 206 with the current geographic position of the subscribers. The base station 102 may also query the cell phone company's servers and/or databases 210 to determine the type of cell phone or mobile device that a subscriber is using. This information may be important because advertising messages explained hereinafter may be tailored to the mobile device and targeted to users based on their geographic location.

The base station 102 may update its databases 206 with information from the cell phone company's servers and/or databases 210 at any suitable interval. Because of the large volume of information, the update should preferably occur at night or when the workload of the base station 102 is low. Access to the cell phone company's servers and/or databases 210 may be through any bridging protocol. An acceptable choice may Open DataBase Connectivity (ODBC).

The base station 102 may be connected with a variety of goods and services providers (providers) through a provider internet server 214. The internet server 214 may contain a variety of web applications that allow providers to enter information about their inventory. Providers may use the web applications to “pass” or “take back” inventory to and/or from the base station 102.

For instance a box office may wish to sell a block of unsold seats at ½ price on the day of the performance. The box office may access a web application available on the provider internet server 214. The web application may contain a form with cells to be populated by the provider with information about the ticket to be “passed” to the base station 102. The form may have cells for seat numbers, row number, price, time of the performance, or any other information that might influence a purchasing decision.

Other web applications may allow providers to enter recurring inventory to be passed to the base station 102. For example, a restaurant may have 20 reservation slots at 6:00 p.m. on every Friday evening and 30 reservations on every Thursday evening that it would like to fill. The web application may allow the restaurant to pass a month, a year or even perpetual inventory to the base station 102.

Web applications that enable entry of inventory may be fairly sophisticated. The applications may have embedded constraint checking and provide real time feedback as to whether the inventory item is an acceptable inventory item. They may also allow a flexible pricing schedule of the inventory item such as premium prices for sales between certain dates and discounted prices for sales between other dates. They may also allow providers to specify a start date and stop date for sales of items in the inventory.

Although inventory passed between a provider and the base station 102 may be passed through the Internet using web applications, the base station 102 may also contain other data communication systems for passing inventory such as telephone keypad entry, voice recognition software, email, etc. A customer service representative may also enter inventory.

The base station 102 may also feature a subscriber internet server 216 featuring web applications that allow potential subscribers to subscribe. The subscriber internet server 216 may also allow users to enter or update their declared interests. These interests may be stored in one of the base station's 102 databases 206 (the patron database). The declared interests may include specific interests as well as genre. For example, a subscriber may declare they are a Lakers' fan, a Pavarotti fan, and that they like Bertucci's Italian restaurant. The subscriber may also specify they enjoy sports, the opera and dining out at Italian restaurants. A subscriber's declared interests make up a part of a subscriber's profile.

The base station 102 may update the subscriber's profile with acquired information about each subscriber, such as the subscriber's current geographic location determined via the cell phone company database 210 or by the subscriber's historic buying patterns. The base station 102 may also add perceived interests to the subscriber's profile.

When an inventory item becomes available, the base station 102 may mine the patron database 206 searching for subscribers who might be potential customers. The base station 102 may compare individual subscriber profiles with the item of inventory and score the profiles based on many factors including probability of making a sale, subscriber profitability and proximity to the good or service. The base station 102 may then select the subscribers to target.

An item of inventory may be of interest to all subscribers in a geographic location. In this case, the base station 102 mines the patron's database for customers currently in the geographic location and selects all subscribers in that area to target. For example, a ticket to a world cup event or an Olympic sporting event may have such universal appeal that targeting subscribers solely on geographic location may be a good strategy.

The base station 102 may generate advertisements to send to subscribers. Advertisements may be sent in a variety of formats. The advertisement may be a simple text message transmitted to a subscriber's mobile device. The advertisement may be an email to a subscriber's email address. It may also be a pop up chat window. The advertisement may also be a voice message to a mobile device generated via a voice synthesizer. It may also appear as a menu tree on a mobile device. The advertisement may also be an HTML message transmitted to web enabled phones. The advertisement may be passive such as a web page or portion of a web page on one of the base station 102 servers.

A subscriber receiving a targeted advertisement may respond by requesting information or making an offer for purchase. Single line text devices may require a series of responses to narrowing questions to complete the offer. For example, the base station 102 may transmit a message such as Lakers tickets available tonight. Are you interested press 1 for Yes or 0 for No. If the user responds with a 1, the base station 100 may transmit a text message such as how many tickets are you interested in, followed by the # sign. A web enabled mobile device may receive the advertisement in the form of an HTML window that shows tickets, a seating chart, prices and all the information necessary for a subscriber to make a purchasing decision.

The passenger in the subscriber vehicle may then make an offer to purchase. The offer to purchase may be made via the input device even though the advertisement was received on or through another device. A cell phone advertisement may allow the subscriber to make the offer to purchase by pressing a number or letter or entering a series of keystrokes on the keypad. If the advertisement is an HTML web page, the subscriber may be able to make the offer to purchase by clicking a button. The subscriber may respond to the message using a different medium. For example, a cell phone text message may have an advertisement that gives a web page address or a telephone number for purchasing the available item.

Offers to purchase may also be made without a targeted advertisement. A ticket machine may offer tickets in a point of sale transaction. The ticket machine may make the offer to purchase through the internet ticket server 222 in the base station 102. Box offices and other ticket outlets may make an offer to purchase tickets via web applications through an internet venue server 224 in the base station 102. Cell phone users may send a text message, use a star number, use a website or call a number and wait to make the offer to purchase. The base station 102 may respond with a “what are you interested in” message, menu tree, or HTML page for web enabled phones.

If the passenger in the subscriber vehicle makes an offer to purchase, the base station 102 may verify that the inventory item is still available. If the item is available, the base station 102 may complete the transaction. A confirmation number, ticket number or similar message may be sent to the passenger in the subscriber vehicle. The transaction confirmation may allow the subscriber to print out a paper ticket or may include instructions on how to get the ticket (e.g., will call). Some providers may accept presentation of a confirmation message as proof of purchase or proof of reservation.

The base station 102 may have the subscriber's credit or debit card number in its patron database or the user may have keyed the number into a cell phone or entered it via a keyboard. The base station 102 may then charge the user's card for the purchase. The base station 102 may notify the provider of the sale. Some providers may require immediate notification of sale while others may only desire a periodic report. The provider's preference may be specified in the inventory web application.

It should be noted there are many alternate embodiments of the topology of the base station 102. As in FIG. 2 the base station 102 may be divided into multiples computer clusters including the lockserver 204, the computers 208 and the databases 206. The lockserver 204 operations may be managed by a single master lockserver 202 that manages the processes of the individual lock servers 204, thus making the base station 102 a highly distributed, parallel, and fault tolerant system. However, the master lockserver 202, the lockservers 204, the computers 208, the databases 206, and servers in FIG. 2 can be rearranged in countless permutations. Thus, the topology in FIG. 2 is an exemplary embodiment.

One possible topology includes a master lock server 202 and seven computer clusters 208. The first computer cluster 208 may be a reader cluster that parses incoming text messages. The second computer cluster 208 may be a next activity cluster. The third computer cluster 208 may be a next menu writer. The fourth computer cluster 208 may be an email writer that formats an email with addresses for a pop-3 server. The fifth computer cluster 208 may be an order cluster that takes prices. The sixth computer cluster 208 may be a seat server cluster that manages seating information. The seventh computer cluster 208 may generate receipts for the provider or the subscriber.

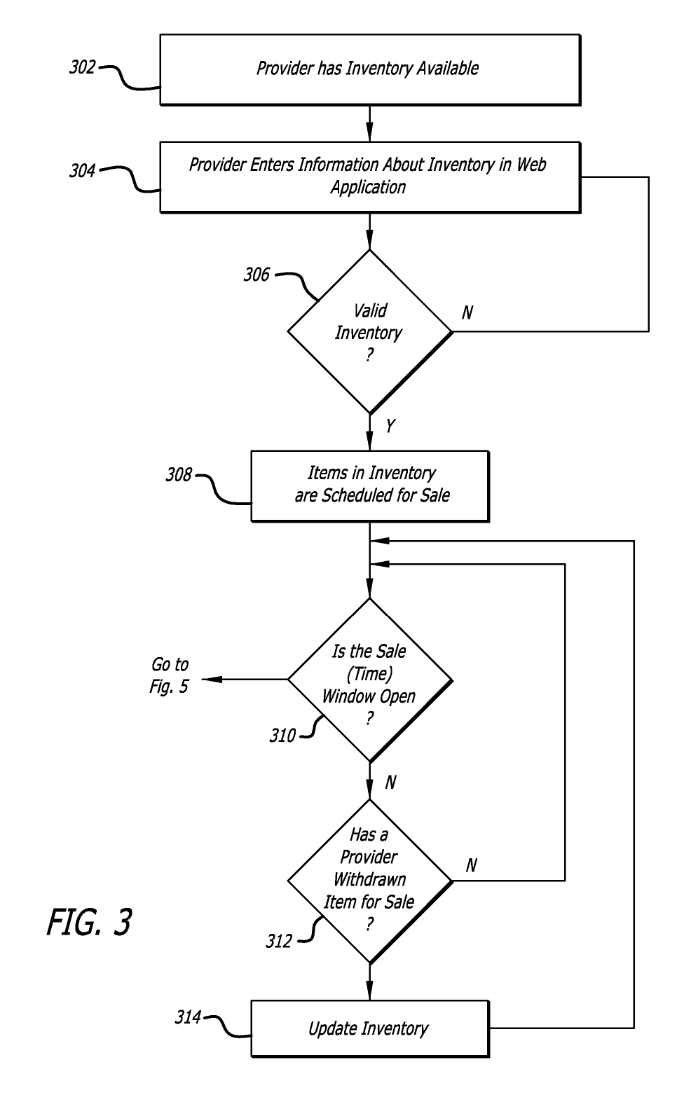

FIG. 3 is a flow diagram illustrating a method of inventory management according to an embodiment of the disclosure. In step 302, a provider determines that at least one item (inventory) is to be made available. Inventory may include tickets, reservations, or virtually any goods or services. The provider, in step 304, enters information about the inventory into a suitable web application. The information may include seat numbers, row numbers, price, dates and times or any other information about a good or service that a customer may want before making a purchasing decision. In step 306, the inventory is validated to determine if the items in the inventory may be sold. Validation may mean simple constraint checking (e.g., verifying ticket or reservation dates are in the future) or may be much more complex with many factors being used to determine whether the inventory or items in the inventory should be made available for sale. In step 308, the items are scheduled for sale. Items may be immediately available or they may become available at some future date. The information entered in step 304 may specify dates of sales. In step 310, the items in inventory are checked to see if any of them are currently available. If not, in step 312 the items in inventory are checked to see if the provider has chosen to withdraw an item in inventory or the entire inventory. If so, in step 314, the inventory is updated.

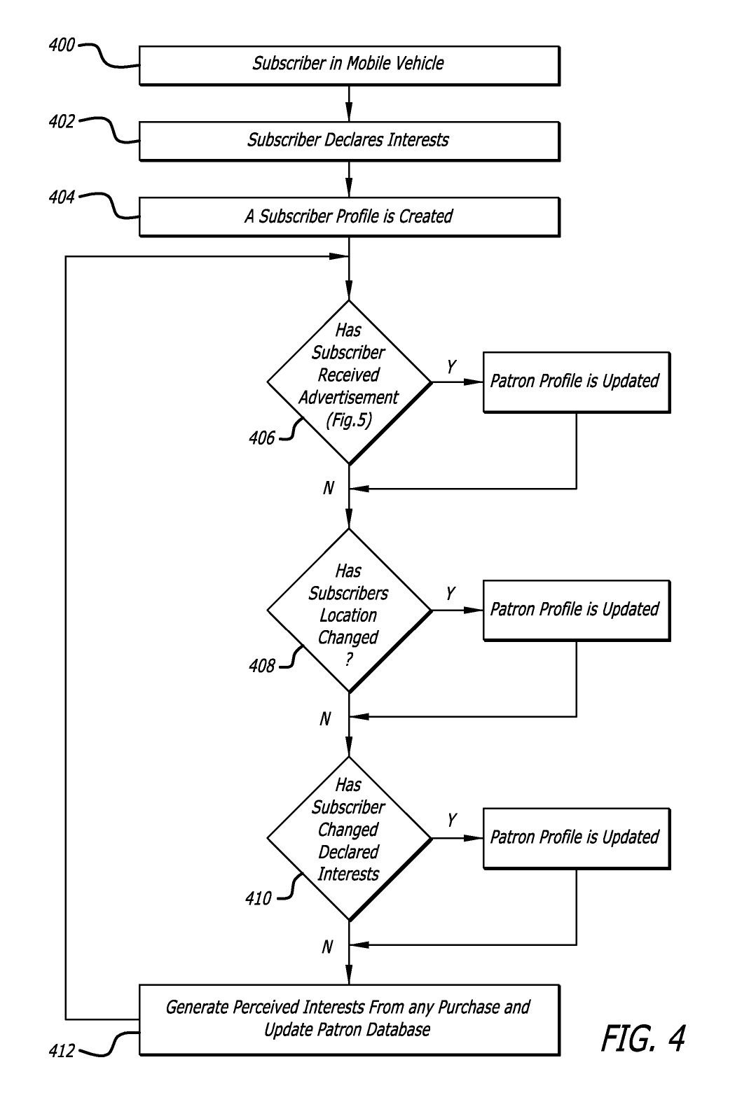

FIG. 4 is a flow diagram illustrating a method of subscriber profile management according to an embodiment of the disclosure. In step 400, a new subscriber is interested in subscribing to the service. In step 402, the subscriber declares his interests in a variety of goods and services. The interests may be very specific or may be a genre. The subscriber may declare his interest via a web application, over the phone, or on paper. In step 404, a subscriber profile is generated and placed in the patron database 206. The profile may include the subscribers' declared interests as well as other information acquired about the subscriber. In step 406, the base station 102 determines whether the subscriber has received any targeted advertisements. If so, the patron profile is updated. In step 408, the base station 102 determines whether the subscriber's location has changed. If so, the profile of the passenger in the subscriber vehicle is updated. In step 410, the base station 102 determines whether the passenger in the subscriber vehicle has amended any of the declared interests. If so, the profile is updated. In step 412, the base station 102 reviews the profile and generates perceived interests based on the information in the database 206.

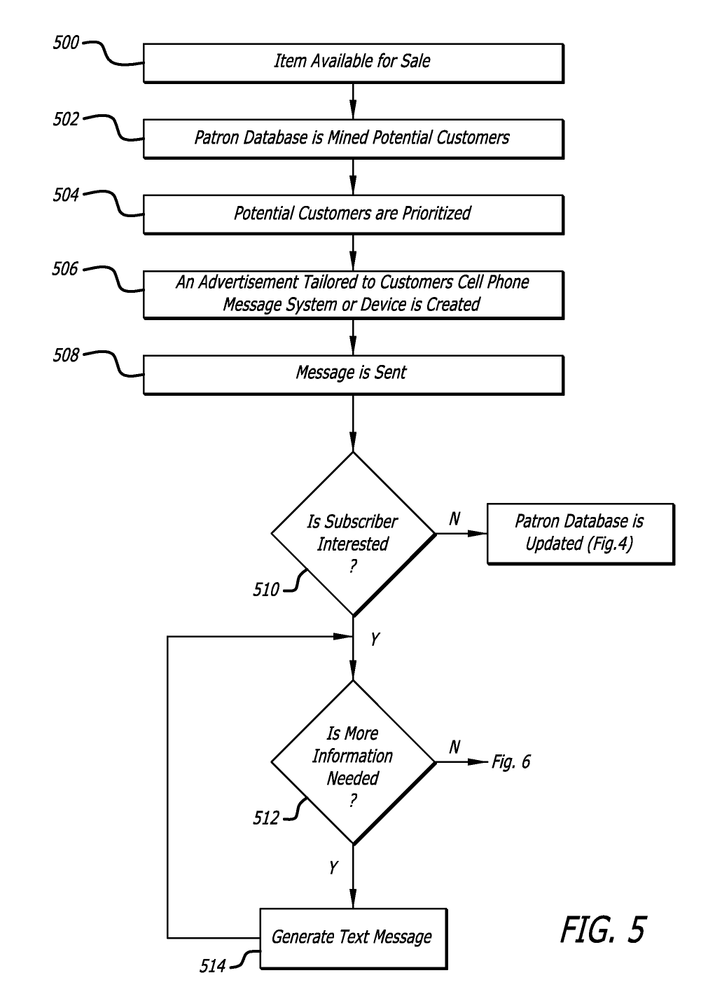

FIG. 5 is a flow diagram illustrating a method of targeting advertisements to passengers and/or mobile vehicle subscribers according to an embodiment of the disclosure. In step 500, the base station 102 has an item of inventory for sale. In step 502, the patron database 206 is mined for potential customers. The passengers and/or mobile subscriber profiles may be scored based on a variety of criteria including likelihood that they will purchase, declared interests, perceived interests, and historic buying patterns. In step 504, the potential subscribers are arranged or ordered based on their scores (e.g., highest to lowest scores). In step 506, targeted advertisements are created tailored to the individual mobile vehicle subscriber input device. In step 508, the messages are sent to the mobile devices. In step 510, the subscriber indicates if he/she is interested in the advertised merchandise. If so, the subscriber may indicate he/she needs more information. In step 512, the base station 102 determines if the subscriber indicated he/she needs more information. If so, in step 514, the base station 102 generates a text message with more information.

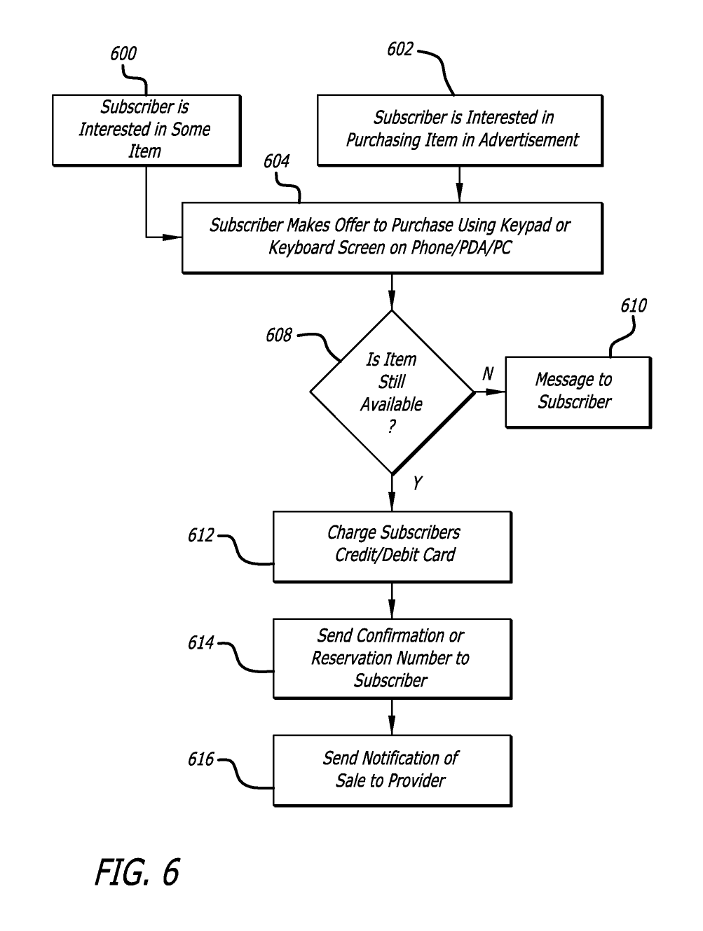

FIG. 6 is a flow diagram illustrating a method of purchasing an item or making a purchase according to an embodiment of the disclosure. In step 600, a passenger and/or subscriber is interested in purchasing an item or making a reservation. The passenger may not even be sure the item is available. The passenger may initiate contact with the base station 102 by calling a phone number, pressing a star number, using the Internet, or any other suitable communication method. Alternatively in step 602, the passenger may have received a targeted advertisement from the base station 102 about an item he/she are now interested in. In step 604, the purchaser makes an offer to purchase. The purchaser may make the offer using a cell phone keypad, a cell phone menu tree, an HTML web page on a cell phone, a computer, or by voice using the telephone. In step 608, the base station 102 verifies that the item is still available. If the item is not available, the base station 102 sends a message to the subscriber indicating that the item is no longer available (step 610). If the item is available, the base station 102 charges the passenger's credit/debit card (step 612). In step 614, the base station 102 sends a confirmation number, reservation number, or some other evidence of purchase to the subscriber vehicle's input device. In step 616, the base station 102 notifies the provider that the item has been sold.

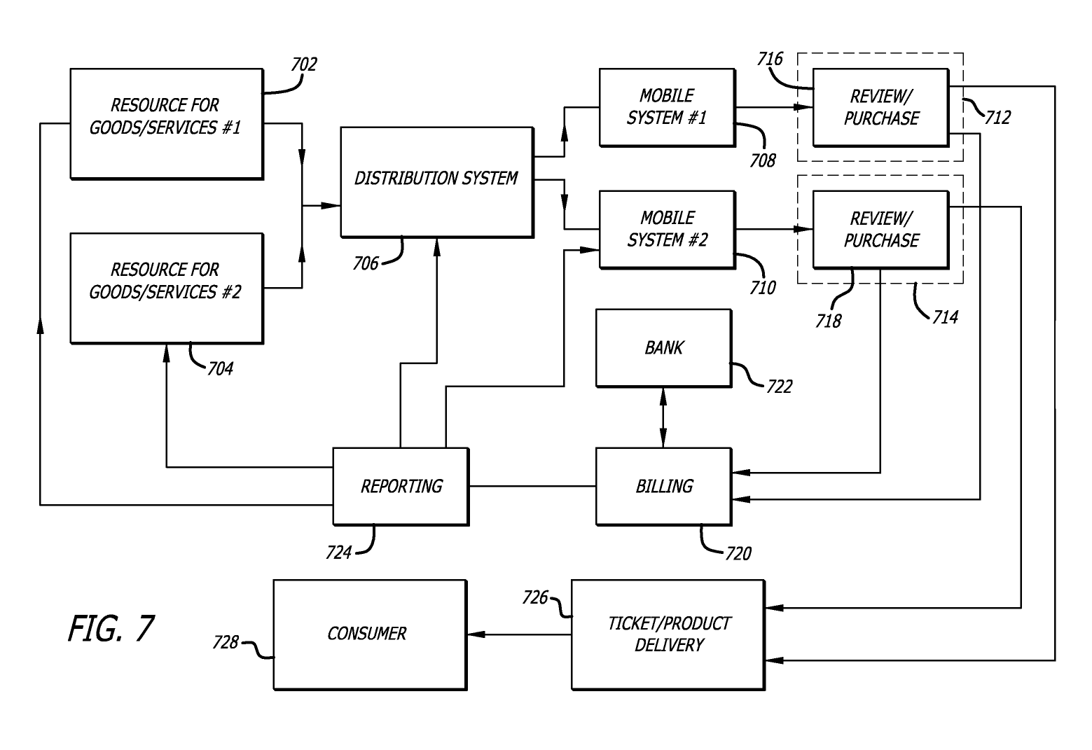

FIG. 7 shows a first resource for goods and services 702 and a second resource for goods and services 704. Inventory from these resources are sent electronically to a distribution system 706 which is part of a service system and central control for the system. This distribution system makes the inventory available to the different mobile systems; for instance, a server for a first mobile system 708 and a server for a second mobile system 710. This inventory can be goods or services and, as such, can be entertainment in the nature of theater, movies or sports events or eating reservations at participating restaurants. Other examples can be, for instance, occupancies in hotels. A consumer or passenger in a mobile vehicle in 712 or a mobile vehicle 714 can review and/or purchase selected items from the inventory as indicated in blocks 716 or 718 respectively.

After a purchase is made and a credit card is processed, a billing process 720 is affected. Charges are directed to a bank 722. Reporting 724 is affected of the billing later or contemporaneously with the billing. The reporting of the sales can be made to the suppliers 702 and 704, the distribution system 706 and the mobile systems 708 and 710, respectively. Tickets, reservations, vouchers or products are delivered as indicated by blocks 726 to the consumer 728. The consumer would be, in most cases, the passenger traveling in the mobile vehicle 712 or 714. In other cases, the consumer could be someone different if so selected by the passenger using the system in the mobile vehicle 712 or 714.

While the apparatus and method have been described in terms of what are presently considered to be the most practical and preferred embodiments, it is to be understood that the disclosure need not be limited to the disclosed embodiments.

While in some cases there is a motor vehicle, such vehicle being non-personally owned by a passenger involved, there could be some other public vehicles involved for housing and locating the computer system. These could be airplanes, buses, metro systems, ferries and the like.

Although the system describes one application where the there is a base, there are many variations of implementation. For instance, there can be a system where there is no base and the mobile vehicles communicate directly with a ticketing/goods clearinghouse or directly with each entity making goods, services or tickets available. Also, the application is applicable in different forms to the availability of non-discount goods, services or tickets.

It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system for placing orders comprising:
an input device mounted on a mobile vehicle,
the mobile vehicle being owned or operated by a first entity and the vehicle being for transporting a passenger between different locations, the passenger being different to the owner or operator,
the input device being selectively a PC, mobile phone, PDA unit associated with the vehicle; the association being such that when an order is made from that device by the passengers, at least one of the owner or operator of the vehicle obtains a financial benefit from the order by the passengers.

2. A system as claimed in claim 1 wherein the placing of the order is the making of a reservation for an entertainment or sporting event.

3. A system as claimed in claim 1 wherein the association of the input device with the vehicle includes a receptacle built into the vehicle for receiving the PC, mobile phone, or PDA unit, the unit being physically and electronically associated with the vehicle.

4. A system as claimed in claim 1 wherein the association of the input device with the vehicle includes hardware and software in the vehicle for interaction with the input device, and wherein the input device is selectively keys on a keyboard, a touch screen or voice activation.

5. A system as claimed in claim 1 including a resource for orders of goods or services accessible by the input device associated with the vehicle.

6. A system as claimed in claim 1 comprising:
a resource of selected goods and services allocatable to the input device for placing orders for selected goods or services;
there being a network of different input devices with respective different mobile vehicles for accessing the system to place orders for the goods or services;
a system for delivering the goods or services in response to the orders for the goods or services;
a system for billing for the selected and purchased goods or services and for submitting a commission or payment to the owner or operator of the mobile vehicle in proportion to a payment by the passenger for the supplied the goods and services; and
a system for making a payment to the resource of goods or services as a payment for those goods or services.

7. A system as claimed in claim 1 wherein the goods or services are delivered electronically in the form of a voucher, a ticket receipt or reservation and wherein the system permits for an access to a service purchased, entertainment or supply of goods on presentation of the voucher, ticket, receipt or reservation.

8. A system as claimed in claim 1 wherein the mobile vehicle is a taxi, limousine or public transportation vehicle.

9. A system as claimed in claim 1 wherein the goods or services are determined for availability in relation to different geographical areas, and wherein access to goods and services are related to the general location of a mobile vehicle in a designated geographical area relative to the goods in a geographical area related to the location of the vehicle.

10. A system as claimed in claim 1 wherein the vehicle is related to its location in a defined geographical area, and wherein the goods and services are provided outside of the defined geographical area of the location of the movable vehicle, and providing for different goods or services for selected different geographical areas to be made available to the mobile vehicle relative to the location of the mobile vehicle, the different geographical areas being other than the defined geographical area.

11. A system as claimed in claim 1 wherein the goods or services are priced at a discount relative to a full price of the goods or services, and wherein the goods or services are dated such that an event related to the goods or services expires on a first date and the availability of the goods or services made available to the mobile vehicle is limited to that time, such that the discount increases relative to a decrease in the time between access to the input device and the occurrence of an event represented by the goods or services.

12. A system as claimed in claim 1 wherein the input device includes an interface permitting passengers being transported in the mobile vehicle to transact an order for goods or services and being for a reservation for entertainment, or for eating, or wherein the input device is a permanently-mounted voice or data input system on the mobile vehicle, and wherein a reservation voucher, ticket or receipt for entertainment or eating can be delivered to an e-mail address, other site or at a venue for the show or eating location.

13. A system as claimed in claim 1 wherein the input device includes an input of credit card information selectively by a receiver permitting insertion of a credit card into a receptacle and including a printer for a voucher.

14. A system as claimed in claim 1 wherein the vehicle housing for the input device and wherein the housing includes, in part, a location in a compartment different to a passenger compartment of the vehicle.

15. A system as claimed in claim 1 including a system for reporting, the reporting including sales data and payment data, and wherein the input device includes a unique electronic address and including a tracking system for permitting an owner of a transportation system of multiple mobile vehicles employing the system, a system to track sales of orders in respective mobile vehicles.

16. A system as claimed in claim 1 including a network permitting access to reports by e-mail or fax, the network being accessible by a vehicle owner, a system operator and vendors of goods and services.

17. A system as claimed in claim 1 comprising:
a base station including:
a plurality of computer clusters having a server, a plurality of computers and a database;
a master server that controls the activities of the servers in the plurality of computer clusters; and
an internet server connected with the master server;
a database bridge connected with at least one of the plurality of computer clusters for downloading geographic position data of the mobile vehicle; and
a telephone or data connection connected with at least one server and the input device with the mobile vehicle.

18. A system as claimed in claim 1 further comprising a pop3 and smtp server connected with the telephone or data connection for generating and receiving messages.

19. A system as claimed in claim 17 wherein one of the databases contains information about the mobile vehicle.

20. A system as claimed in claim 17 wherein one of the databases contains provider inventory information of goods or services.

21. A system as claimed in claim 17 wherein one of the computers matches inventory information of goods or services with a mobile vehicle.
